(19) United States
(12) Patent Application Publication
(10) Pub. No.: US 2009/0114489 A1
(43) Pub. Date: May 7, 2009

(54) Coupled Dual Pivot Brake Device

(76) Inventor: Matt Simkins, Redwood City, CA (US)

Correspondence Address: Matt Simkins, 1039 Cleveland St, Redwood City, CA, 94061, US

(21) Appl. No.: 11/936,057

(22) Filed: Nov. 6, 2007

(51) Int. Cl. B62L 1/02

(52) U.S. Cl. 188/24.22

(57) ABSTRACT

The dual pivot, side-pull type caliper brake described in the current invention comprise of two brake arms. The first brake arm is pivoted to the second arm. The second brake arm pivots on a fixing bolt. The fixing bolt connects the brake caliper to the frame or fork of a bicycle. A Bowden wire actuates the brake arms. A centering spring aligns both brake arms relative to the fixing bolt. The centering spring is preloaded against the fixing bolt, as well as the second brake arm.

### FIELD OF THE INVENTION

This invention is suitable for bicycles, tandems, and recumbents.

### BACKGROUND OF INVENTION

The two most common brakes for road bicycles are single pivot brakes FIG. 3 (a) and dual pivot brakes, see FIG. 3 (b). In order to achieve greater braking power, bicycle brakes utilize mechanical advantage from the brake cable to the brake shoes. The brake members should be stiff enough that the brake does not deflect under high braking loads. It should be lightweight, and have a smaller frontal profile for reduced wind drag. In these ways, the brake will help in yielding overall greater efficiency of bicycles in terms of weight and wind drag. One approach to achieving these goals is to reduce the overall size of the brake.

The state of the art consists of two popular arrangement, single pivot brakes, and dual pivot brakes. For single pivot brakes, both brake arms pivot around a single central pivot, see FIG. 1 (a). For single pivot brakes, the pivot doubles as a fixing member that fastens the brake to a bicycle frame or fork. A Bowden wire actuates the brake pads against a wheel in a scissor style motion.

In the most typical arrangement for dual pivot brakes, a single torsion spring is interposed between a fixing member and one of the brake arms. This arrangement is depicted in FIG. 3 (b), however, the interposed spring is not depicted for clarity. The second brake arm is actuated by the first arm through the contact of a boss, or set screw (the boss is depicted as hidden lines). The return spring, as well as the braking force applied by the brake cable, are transmitted from the first brake arm, through the boss, into the second brake arm, and finally into the brake shoe that are attached to the first and second arm. Additionally, some force is transmitted to the second brake arm from the sheath of the Bowden wire. Both brake arms pivot separately on a fixing member that rigidly attaches to a frame or fork.

In order to retain sufficient leverage, designs similar to FIG. 3 (a) and FIG. 3 (b) requires longer lever arms. Long lever arms tend to increase weight, reduce stiffness, and increase wind drag.

### SUMMARY OF INVENTION

The current invention increases leverage by means of a coupled pivot between the brake arms in order to retain aerodynamic and stiff characteristics of a compact design without having to sacrifice leverage.

An object of this invention is to amplify ratio of Bowden wire force to the squeezing force of brake shoes against a wheel using a compact assembly of parts. Increased leverage is accomplished by lengthening the lever arm from the location that the brake cable attaches to the first arm, to the location that the first brake arm pivots on the second brake arm. The brake is energized when a user applies tension to the brake cable of the Bowden wire. When the brake is energized, the first brake arm applies a force to the braking surface of the wheel through the brake shoe. At the same time, a reaction force to the first brake arm is transmitted through the coupled pivot, to the second brake arm, and in turn, to the opposite brake surface on the wheel. This reaction force ensures that the brake shoes attached to the first and second brake arms will apply equal, and opposite force against the braking surface of the wheel.

One problem that arises with single pivot brakes is that the brakes shoes do not retract from the braking surface of a wheel through an equal distance when the brake is de-energized. This can be caused by small changes in pivot friction due to wear or debris. Unequal return forces when the brake is de-energized can lead to the undesirable results that one brake pad, or the other, will drag against the bicycle wheel when the brakes are not being energized.

An object of the current invention is that the preloaded centering spring keeps the de-energized brake shoes centered regardless of small changes in pivot friction due to wear or debris.

In the preferred embodiment, the coupled pivot axis, the axis of rotation of arm two around the fixing member, the axis of rotation of the legs of said centering spring, and the axis of rotation of the legs of the return spring, are all parallel.

These, and other objects of this invention will become apparent in the detailed description of the accompanied drawings.

### BRIEF DESCRIPTION OF THE DRAWINGS

FIG. 1 is a perspective view of the coupled dual pivot brake device

FIG. 2 is a partial plan view of selected parts depicting the spring orientations for different brake configurations.

FIG. 3 is a plan view depiction of prior art designs.

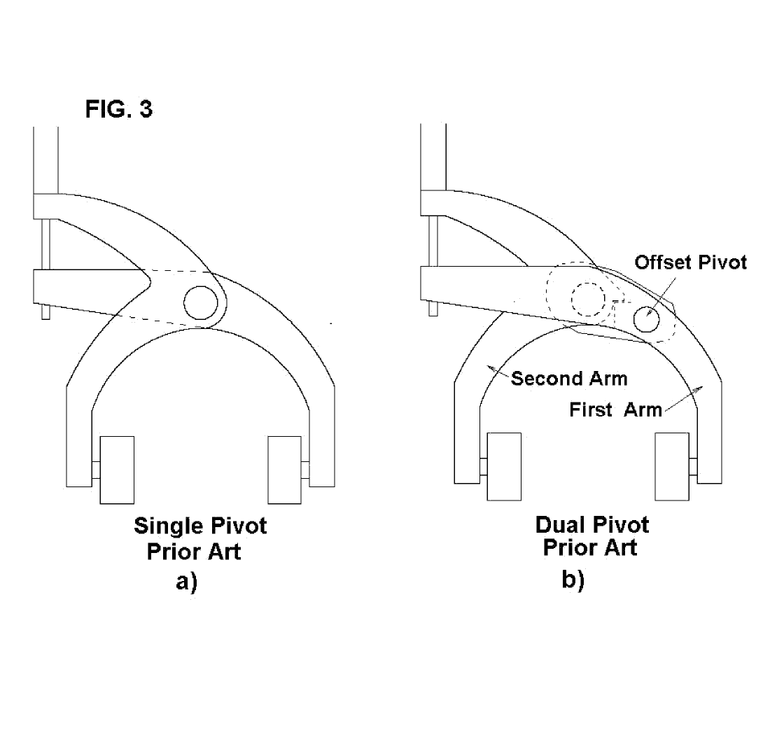

### DETAILED DESCRIPTION OF PREFERRED EMBODIMENT

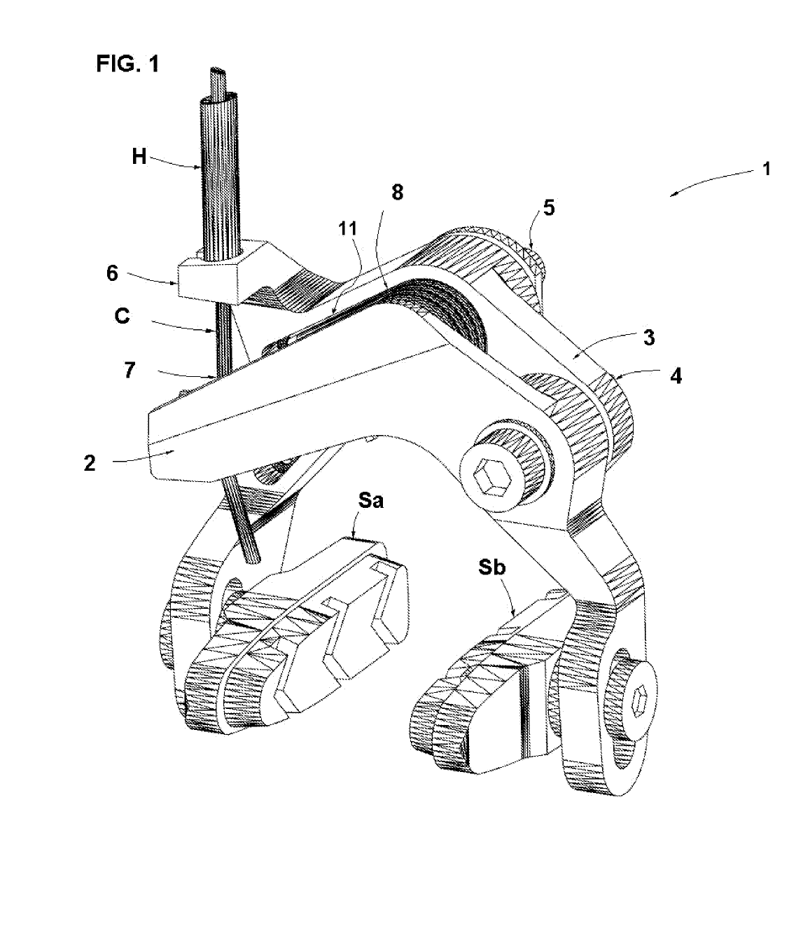

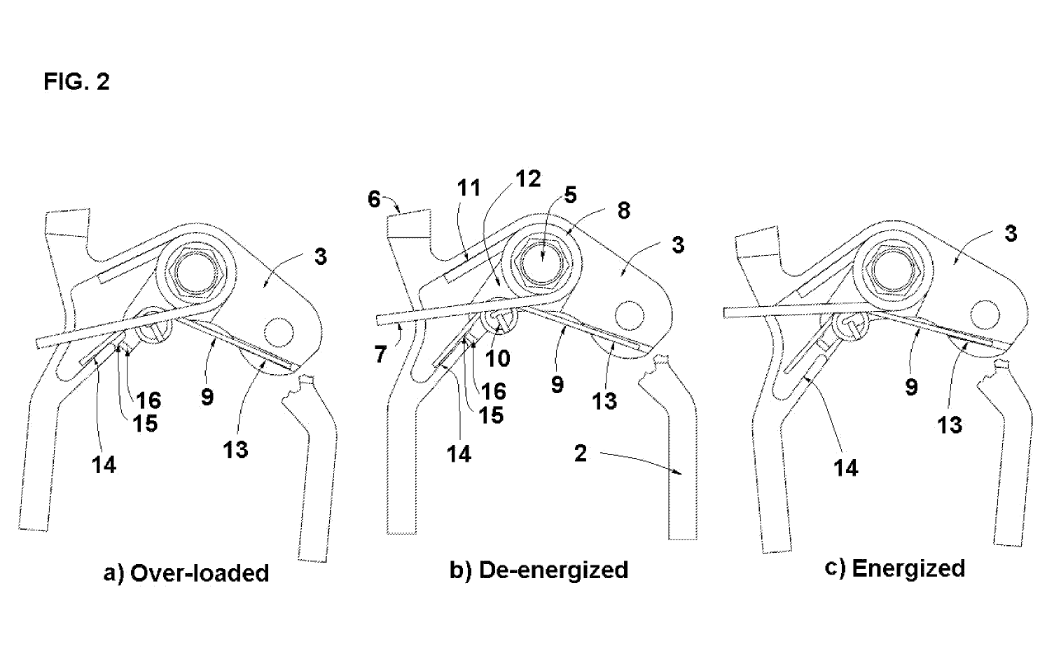

An exemplary embodiment of the invention is a brake device 1 depicted in FIG. 1 and FIG. 2. Referring to FIG. 1, the brake device 1 consists of brake arm 2, and brake arm 3. Arm 2 rotates on pivot bolt 4. Pivot bolt 4 is rigidly attached to arm 3. Arm 3 pivots on fixing member 5. Fixing member 5 rigidly attaches to a frame or fork of a bicycle.

When attached to a bicycle, the circumference of a wheel passes between brake shoes Sa and Sb. Brake device 1 is energized when cable tension is applied to the inner portion of a Bowden wire, so labeled cable C, as depicted in FIG. 1. Cable C passes through an armature at location 6. The armature at location 6 is rigidly connected to arm 3. Cable C is fixedly attached to arm 3 at location 7. When energized, cable C is put into tension by the hand force of a user, and the sheath portion of the Bowden wire, so labeled cable housing H in FIG. 1, compresses against arm 3, at location 6.

As shown in FIGS. 1 and 2, return spring 8 is a pre-loaded torsion spring that is interposed between arm 2 and arm 3. In the preferred embodiment, return spring 8 forces Sa and Sb away from the braking surface of a wheel. Return spring 8 induces moment in arm 3 by applying force on arm 3 at location 11, see FIG. 2 (b). Return spring 8 applies force to arm 2 at a contact point at location 7 in FIG. 1 (the contact point on arm 2 is implied on FIG. 2 (b) because arm 2 is depicted as a break-out). When the brake is de-energized, there is no force acting on brake shoes Sa or Sb, therefore, the force that is applied to brake cable C from arm 2, and brake housing H at location 6, originates exclusively from the force that return spring 8 applies to brake arm 2 and brake arm 3, see FIG. 2 (b). The distance between location 6 and 7 in FIG. 1 is limited by the allowable travel of cable C, and by the allowable travel of brake shoes Sa and Sb to the surface of a wheel that passes between the brake shoes.

In the preferred embodiment, fixing member 5 has a threaded shank and locknut (not visible in FIG. 1 or FIG. 2) that rigidly attaches brake device 1 to a frame, or fork. Accordingly, fixing member 5 can be rotated to different positions relative to the frame or fork that brake 1 is mounted. The repositioning of brake 1 is accomplished by loosening a lock nut, readjusting the position of brake 1, and retightening of the locknut. In this way, a user can position brake arms 2 and 3 in such a way that neither brake shoe Sa, or Sb, will drag against the baking surface of a wheel when brake device 1 is de-energized.

When brake device 1 is energized, tension in brake cable C causes a moment in arm 2 around the pivot bolt located at 4, see FIG. 1. In turn, arm 2 is moved into contact with braking surface of a wheel through shoes Sa and Sb. Arm 2 also imparts a reaction force on arm 3 through pivot bolt 4. In the preferred embodiment, the distance from location 7 to pivot 4 is greater than the distance from pivot 4 to Sb. For this reason, cable tension at 7 results in a mechanical advantage, and the normal force of the wheel against Sb will be greater than the cable tension force at location 7.

When the brake is de-energized, the position of brake arm 2 is dependent on the position of brake arm 3. As shown in FIG. 2 (b), center spring 9 rides on a mandrel at location 10. The mandrel at location 10 is rigidly attached to spring retainer 12. FIG. 2 (b) depicts mandrel 10 as a tab is rigidly connected to spring retainer 5. Mandrel 10 in FIG. 2 projects out of the page. Spring retainer 12 is rigidly attached to fixing member 5. Tab stop 16 is rigidly connected to spring retainer 12. In FIG. 2, tab stop 16 projects out of the page in the same way as mandrel 10. Referring to FIG. 2, centering spring 9 is preloaded against brake arms 3 at location 13 and location 14. Centering spring 9 continuously exerts force on arm 3 by contacting a slotted region of arm 3 at location 13. Centering spring 9 exerts force on arm 3 by contacting a ridge that is rigidly connected to arm 3 at location 14. When the brake is de-energized, as is the case with FIG. 2 (b), centering spring 9 pushes arm 3 at location 13 to rotate in a clockwise direction. Referring to FIG. 2 (b), when de-energized, arm 3 is prevented from rotating clockwise by the force applied from centering spring 9 at location 14.

In the preferred embodiment, such as in FIG. 2, because the distance from mandrel 10 to location 13 is greater than the distance form fixing member 5 to location 13, and the distance from fixing member 5 to location 14 is greater than the distance from mandrel 10 to location 14, centering spring 9 exerts induces greater moment on brake arm 3 at location 14 than the moment that is induced by centering spring 9 at location 13 in FIG. 2 (a). Centering spring 9 will rotate brake arm 3 counterclockwise from the position depicted in FIG. 2 (a) until centering spring 9 contacts tab stop 16 at location 15. Thus, in the absents of any outside forces, centering spring 9 will tend to restore brake arm 2, and in turn, brake arm 3, to the de-energized position given in FIG. 2 (b). When brake 1 is de-energized, center spring 9 is prevented from rotating arm 3 clockwise due to the force being exerted at location 14 by one of the legs of centering spring 9. When brake 1 is de-energized tab stop 16 interferes with the leg of centering spring 9 at tab stop 15 thereby not allowing spring 9 to not move arm 3 in a counterclockwise direction past tab stop 16. In this way, brake arm 3 remains in a fixed de-energized position relative to fixing member 5.

Under real world circumstances, a user may overload arm 3 by bumping, or accidentally pushing brake 1 in a clockwise direction as depicted in FIG. 2 (a).

When brake 1 is overloaded, as depicted in FIG. 2 (a), brake arm 3 is rotated clockwise from the de-energized position and centering spring 9 looses contact with tab stop 16 at location tab stop 15. When the force causing the overloading is removed, brake arm 3 will be returned to the de-energized position in FIG. 2 (b) by centering spring 9. In this way, a inadvertent bump of brake device 1 into the position depicted in FIG. 2 (a) will not result in a misalignment of fixing member 5.

In the de-energize state, because the position of arm 2 is dependent on the arm 3 position, and because arm 3 is dependent on the position of fixing member 5, the position of arm 2 and arm 3 can be determined by the position on fixing member 5. Because the rotational position of fixing member 5 is adjustable relative to the frame or fork that brake 1 is attached to, the de-energized brake shoes, Sa and Sb, can be configured to never contact the braking surface of a wheel when brake 1 is de-energized. In order that the de-energized brake arms 2 and 3 do not become misaligned with the braking surface of a wheel, thus causing brake shoe Sa or Sb to rub on the braking surface of a wheel, fixing member 5 must remain fixed to the frame, or fork of a bicycle.

As the brake arms are energized, brake shoe Sb in FIG. 1 first contacts the braking surface of a wheel, then as further tension is applied to brake cable C, brake shoe Sa is brought into contact with the braking surface of the wheel. When both brake shoes, Sa and Sb, have been brought into contact with the braking surface of a wheel, and the brake arms are further energized with increased tension on cable C, brake shoes Sa and Sb apply a squeezing force to the wheel (not shown) between brake shoes Sa and Sb. When the brake is energized, as in the case of FIG. 2 (c), centering spring 9 will loose contact with arm 3 at location 14, and remains in contact with arm 3 at location 13. When brake 1 is de-energized after being energized, brake arms 2 and 3 will return to the de-energized position and depicted in FIG. 2(c).

What is claimed is:

1. A side-pull type brake that consists of two arms that are each fixedly attached to a brake shoe, and the first brake arm is attached to a Bowden wire cable, and the second arm contacts a Bowden wire sheath, whereby the first brake arm is pivotally attached to the second brake arm by a coupled pivot, and the second brake arm is pivotally attached to a fixing member that can be rigidly mounted to the frame, or fork, of a bicycle.

2. The bicycle in claim 1 contains at least one wheel that doubles as a braking surface whereby braking is accomplished by a squeezing force of the brake shoes against said wheel.

3. Said coupled pivot is located at a distance from said fixing member pivot, as set forth in claim 1.

4. Said Bowden wire sheath contacts said second brake arm at a distance from said fixing member pivot, as set forth in claim 1.

5. Said brake shoe is fixedly attached to said first brake arm at a distance from said coupled pivot, as set forth in claim 1.

6. Said Bowden wire sheath contacts said second brake arm at a distance from said coupled pivot, as set forth in claim 1.

7. Said distance in claim 6 is greater than each distance described in claims 5, 4, and 3.

8. Said Bowden wire cable attaches to said first brake arm at a distance from said coupled pivot, as set forth in claim 1.

9. Said distance in claim 8 is greater than each distance described in claims 5, 4, and 3.

10. Both brake arms in claim 1 are positioned relative to said wheel in claim 2 by spring preloading the brake arm that is pivotally attached to the fixing member in claim 1 by means of a torsion type centering spring such that the centering spring legs both continually contact the preloaded brake arm, one of the centering spring legs exerts a force on a stop, and the axis of rotation of the centering spring arms coincide with the position of a mandrel.

11. Said mandrel in claim 10 is rigidly attached to said fixing member in claim 1.

12. Said stop in claim 10 is rigidly attached to said fixing member in claim 1.

13. One of the said centering spring legs exerts force at a location on the said preloaded brake arm in claim 10 thereby inducing a moment on said preloaded brake arm around said fixing member pivot described in claim 1.

14. The centering spring leg in claim 13 exerts a contacting force on said stop in claim 10.

15. The centering spring leg not described in claim 13 exerts force on said preloaded brake arm in claim 10 thereby inducing a moment on the preloaded brake arm around said fixing member pivot in claim 1.

16. The said moment being applied by the centering spring leg in claim 13 is equal and opposite to said moment being applied in claim 15.

17. The position of the mandrel in claim 6 is located at a fixed distance from the pivot of the preloaded brake arm in claim 10.

18. The centering spring leg in claim 13 exert a force on said preloaded brake arm in claim 10 at a changing distance from the fixing member pivot.

19. Said distance in claim 17 is always less than said distance in claim 18.
